(19) United States
(12) Patent Application Publication
(10) Pub. No.: US 2024/0127420 A1
(43) Pub. Date: Apr. 18, 2024

(54) Evaluating a Surface Microstructure

(71) Applicant: PDF Solutions, Inc., Santa Clara, CA (US)

(72) Inventors: Peter Kostka, Vancouver (CA); Jenna Slomowitz, Vancouver (CA); Darcy Montgomery, Burnaby (CA)

(73) Assignee: PDF Solutions, Inc., Santa Clara, CA (US)

(21) Appl. No.: 18/487,960

(22) Filed: Oct. 16, 2023

Related U.S. Application Data
(60) Provisional application No. 63/417,132, filed on Oct. 18, 2022.

(51) Int. Cl. G06T 7/00; H01M 4/139; H01M 10/42

(52) U.S. Cl. CPC G06T 7/0006; H01M 4/139; H01M 10/4285; H01M 2004/021

(57) ABSTRACT

A method of evaluating the microstructure of a surface, such as a coating on a substrate. The surface is illuminated using at least one light source. One or more images of the illuminated surface are captured. The captured images are processed to identify one or more features of the microstructure, and then determine one or more parameters of the microstructure features. The parameters are compared to thresholds or limits to determine whether remedial action is needed.

### CROSS-REFERENCE

This application claims priority from U.S. Provisional Patent Application No. 63/417,132, filed Oct. 18, 2022, entitled Method and System for Evaluating a Microstructure of a Surface, the entire disclosure of which is incorporated herein by reference.

### TECHNICAL FIELD

The present disclosure relates to microscopy, and in particular to methods and systems for evaluating the microstructure of a surface.

### BACKGROUND

Electrode microstructure is known to have a profound effect on lithium-ion battery performance. Some of the better-known microstructure features and corresponding impacts include: active material spatial distribution affecting utilization efficiency and therefore directly impacting manufacturing cost per given capacity; binder distribution affecting long-term stability and response to thermal cycling; and grain size in general affecting dendrite growth which in turn has a significant effect on long-term Coulombic efficiency.

Existing methods that attempt to measure the factors described above typically rely on transporting samples of electrode material to measurement equipment that is physically separated from the electrode manufacturing operation. Obvious drawbacks to this method include the high cost associated with sample handling as well as production interruption. Furthermore, because of its high cost, such a method is generally reactive, i.e., the method seeks to identify flaws in the end product only once gross problems are suspected in response to large process changes or poor test results, or over extended periods of time.

It would be desirable to have improved analytical methods for evaluating surface microstructures.

### SUMMARY

The microstructure of a surface, such as a coated surface as manufactured for a battery anode or cathode, may be evaluated by illuminating the surface and capturing images of the illuminated surface. The images are processed to identify one or more features of the surface microstructure, such as pores, grains of active material, clumps of active or inactive material, surface texture, the inclusion of any mixing precursors, the distribution of binder material. Once microstructure features are identified, relevant parameters are generated from the image processing, such as a size, a shape, a spatial distribution, or a color of the feature. These parameters are compared to thresholds to determine whether remedial action is needed.

### BRIEF DESCRIPTION OF THE DRAWINGS

FIG. 1 is a flow diagram of an exemplary method of evaluating a microstructure of a coating.

FIG. 2 is a schematic diagram of an exemplary system for evaluating a microstructure of a coating.

FIG. 3A illustrates components of an exemplary system for evaluating a microstructure of a moving coating.

FIG. 3B illustrates the surface illumination and imaging module shown in FIG. 3A.

FIG. 4 is a flow diagram illustrating one method for detecting and parameterizing surface microstructures.

### DETAILED DESCRIPTION

The present disclosure provides methods and systems for evaluating the microstructure of a surface, such as a coating formed on a substrate. While various embodiments are described, the disclosure is not intended to be limited to these embodiments.

In its simplest form, the microstructure of a manufactured surface may be evaluated by obtaining an image of the manufactured surface, then processing the image to detect and identify a microstructure feature of the surface. A parameter is generated to characterize the identified microstructure feature, and the generated parameter is then used to evaluate the quality of the manufactured surface. Upstream or downstream remedial measures may be appropriate if the generated parameter associated with the surface feature is found to be out of limits, or is likely to impact performance of the surface, for example, as determined by PDF Solutions, Inc.'s Yield-Aware Fault Detection and Classification (YA-FDC) solution running on the Exensio® analytics platform.

As used herein, a microstructure generally refers to the shape and position of surface features with sizes below 100 microns (i.e., not visible to the human eye). Examples include a surface which is deposited directly onto a substrate using known methods such as vapor deposition, electroplating, wet coating, or spray coating; or a surface that is first formed into a continuous layer and then bonded onto a substrate or formed into a laminate with other layers. As one example, the surface may be a coating or layer deposited on an electrode (anode or cathode) of a battery. The surface may also be a coating or layer deposited on a photovoltaic panel, or as used in a catalytic converter or CO₂ capture materials.

In particular, the microstructure of the coating of a battery electrode may be evaluated, for example, by imaging the coating, detecting and identifying one or more features of the constituent materials of the coating, and then measuring and parameterizing the features. Features such as pores, grains of active material, clumps of active or inactive material, surface texture, the inclusion of any mixing precursors, and the distribution of binder material, are examples of common microstructure surface features that may be imaged and measured or otherwise parameterized through processing. In addition, other parts of the manufacturing process may introduce other features of interest, such as the presence of contaminants, or distortions to the surface coating. Advantageously, the evaluation of such features may take place on an active manufacturing line without disrupting or displacing the coated material. The parameters that may be generated to be associated with or corresponding to each identified feature include a size, a shape, a spatial distribution, or a color, and a value and a threshold (or limit, or range, etc.) may be assigned for each parameter. These parameters can be combined with test data, metrology data (including virtual metrology) and/or other relevant information to determine single-variable or multi-variable thresholds or sets of ranges or limits that impact downstream processes or overall product performance. Determination of thresholds or limits can be done through statistical sensitivity analysis, or outlier detection (such as DBScan), or through the creation of machine learning models representing the input-response relationship.

Analysis of the image data is facilitated by the emergence of parallel processing architectures and the advancement of machine learning algorithms which allow users to gain insights and make predictions using massive amounts of data, including the complex and multivariate relationship and behaviors of the data, at speeds that make such approaches relevant and realistic for use in near-real time. Thus, machine learning models can be very useful when trained to evaluate the surface images in order to facilitate analysis of surface features. Some of the known ML algorithms include but are not limited to: (i) a robust linear regression algorithm, such as Random Sample Consensus (RANSAC), Huber Regression, or Theil-Sen Estimator; (ii) a tree-based algorithm, such as Classification and Regression Tree (CART), Random Forest, Extra Tree, Gradient Boost Machine, or Alternating Model Tree; (iii) a neural net based algorithm, such as Artificial Neural Network (ANN), Deep Learning (iv) kernel based approach like a Support Vector Machine (SVM) and Kernel Ridge Regression (KRR); and others.

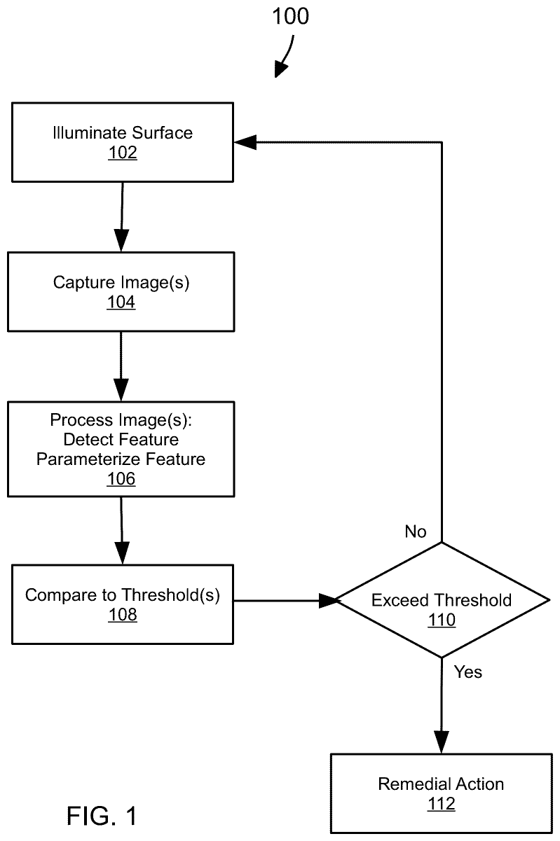

According to exemplary embodiments of the disclosure, the microstructure of a surface may be evaluated using the method 100 shown as a flow chart in FIG. 1. In step 102, the surface of interest is illuminated using a light source. In a general example, the surface of interest to be evaluated is a coating or layer being applied to a substrate in a real-time manufacturing operation, and therefore the surface is typically moving relative to a fixed light source. In step 104, images of the illuminated surface are captured using a suitable image capture device, such as a digital camera. In order to better capture images, light reflected from the illuminated coating is preferably focused onto the image capture device using a focusing assembly, such as a system of one or more lenses, as is well-known. In step 106, each captured image is processed in order to detect and identify one or more microstructure features, and also to generate parameters that characterize the microstructure features identified in the surface coating in a meaningful and useful manner. In step 108, the generated parameters are compared to defined thresholds or ranges or limits in order to evaluate the quality of those parameters as it relates to the overall quality and performance of the manufactured surface. If, in step 110, the comparison reveals that one or more parameters exceed their corresponding threshold, then remedial action may be indicated, and such action is taken in step 112. For example, one or more upstream process parameters may require modification, or some secondary downstream may be enabled to attempt correction, if possible; or if not, to remove the flawed material from further processing. The process may be continuous, returning to step 102 to monitor the ongoing manufacture of the surface of interest.

Since battery cell performance is affected by the microstructure of the coating, evaluating features of the microstructure coating can enable a user of the system to better assess the likely performance of the battery cell. Advantageously, as noted above, the coating may be evaluated in near real-time. Further, prompt analysis allows prompt remedial action. Examples of process parameters that may be controlled or adjusted include: coating speed; temperature; pressure; mixing speeds; calendaring pressure; cutting speed; component quantities including quantities of additives designed to make the coating more robust; and any other parameter that is specific to a particular application and/or coating machine. Coating speed refers to the speed of the substrate moving relative to a fixed dispensing device, or it may refer to the flow rate of material being dispensed from a dispensing device. A mixing speed refers to the amount of agitation or shear imparted to constituents in a mixing process, and is typically related to the speed of a mixing blade or blades relative to a stationary vessel, or the speed or vibration of the mixing vessel when the vessel is not stationary. Sensors are typically employed to monitor the manufacturing equipment and processing parameters in well-known manner, and information from the sensors is useful in devising solutions to quality deviations, such as appropriate upstream or downstream steps to correct or mitigate problems associated with detected deviations for one or more surface features.

Advantageously, evaluating the microstructure in real-time may enable more rapid and efficient intervention in the event that the quality of the microstructure is determined to have degraded past a certain threshold point. This is in contrast to traditional methods of assessing coating microstructure, wherein a process which analyzes only a few specific samples may miss microstructure variations which are spatially or temporarily non-uniform.

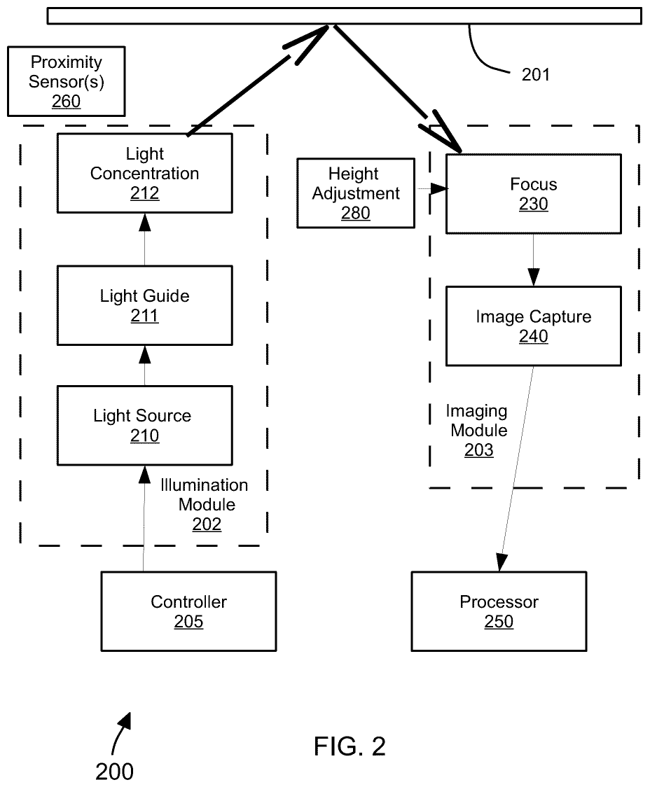

Turning to FIG. 2, there is shown a schematic block diagram of an example system 200 for imaging and evaluating the microstructure of a coated surface 201 (which may simply be referred to as “coating 201”). System 200 includes a sample illumination module 202 that emits light 215 onto surface 201 as directed by a control module 205, and an imaging module 203 that captures light 225 reflected from surface 201. The collected light is then sent to computer processor 250 for processing and evaluation of surface images.

In a preferred configuration, the illumination module 202 includes a light source 210 connected to a light concentration assembly 212 via a light guide 211, and the imaging module 203 includes a focusing assembly 230 and an image capture device 240. The illumination module 202 is positioned so as to emit light 215 onto coating 201 to thereby illuminate the coating. According to some embodiments, a light source may be mounted sufficiently close to the surface to emit light directly onto the coating 201 without the need for light guide 211 and light concentration assembly 212 as shown in FIG. 2.

Light concentration assembly 212 provides a termination point for light guide 211 as well as multiple reflection surfaces for improving light uniformity. Light concentration assembly 212 may be made by coating or polishing a 3D-printed, machined, cast, or molded component. Light concentration assembly 212 also provides mechanical attachment points for light guide 211 and may be equipped with one or more proximity sensors 260 to ensure that physical contact between light concentration assembly (or more generally, illumination module 202) and coating 201 is avoided.

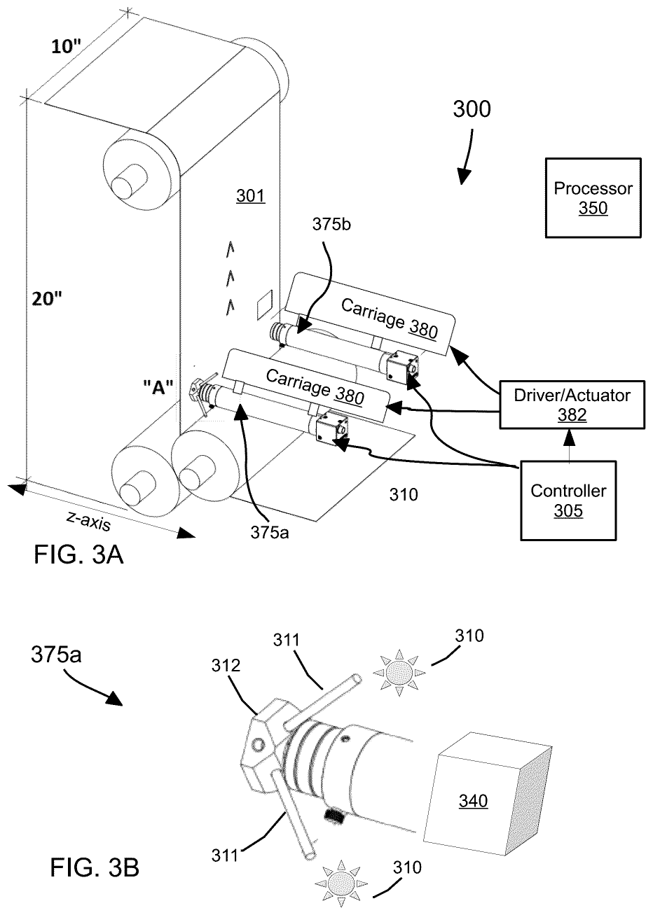

Focusing assembly 230 and image capture device 240 are positioned relative to one another such that light 225 reflected from coating 201 is focused by focusing assembly 230 onto image capture device 240. Focusing assembly 230 may include a mechanism 280 for actively adjusting a height (i.e., a distance along the z-axis shown in FIG. 3A) of image capture device 240 or adjusting a lens assembly in focusing assembly 230 relative to coating 201. The image capture device 240 and focusing assembly 230 may be controlled together to move as one relative to coating 201. Images captured by image capture device 240 are then transferred (for example, by a wired or wireless link using known communication protocols) to computer processor 250 for subsequent processing.

As shown in FIGS. 3A and 3B and described below, the illumination module 202 and imaging module 203 may be integrated into a single illumination and imaging apparatus 375.

Control module 205 is operatively connected to light source 210 and is configured to modify one or more parameters of the light source. For example, control module 205 is configured to pulse one or more light sources, and may deliver a fixed-length current pulse to light source 210, with a duration ranging from 1 to 100 microseconds. The relatively short duration of the pulse allows for imaging of coating 201 that is moving rapidly in the field of view of image capture device 240, as described in further detail below. The interval between pulses is generally much longer than the duration of individual pulses, in order to accommodate any latency in image capture device 240 and/or computer processor 250. According to some embodiments, the pulse interval may be set to up to 1 second. Varying the spacing between pulses allows one to balance processing resources with the amount of material that is being analyzed. Other parameters that may be controlled by control module 205 include, for example, the pulse duration/width of each pulse, the light intensity, the illumination direction, and the color (i.e., the wavelength) of the emitted light. The control module 205 may also be processor-based, for example, an application specific integrated circuit (ASIC), or it may be a hard-wired circuit implementation.

According to one example embodiment, for the case of coating 201 moving at a speed of 1 m/s, each pulse may have a duration of 1 microsecond, and consecutive pulses may be spaced by 0.5 seconds in order to provide a resolution of 1 micron (i.e., an area of 1 mm×1 mm) and the ability to inspect 0.2% of coating 201.

Since physical space near coating 201 may be limited by the proximity of the manufacturing equipment, in many applications light source 210 may need to be positioned relatively far from coating 201. Light guide 211 and light concentration assembly 212 are advantageous to channel the emitted light 215 toward coating 201. For example, one or more optical fibers may be used as light guide 211, and if the efficiency of the optical fibers is particularly high, then light source 210 may be placed many meters from coating 201. This may allow a single light source to be used for illuminating multiple coatings, for example, at multiple, independent inspection stations.

Light source 210 and light guide 211 are selected so that a maximum amount of energy is transmitted from the light source to the light guide. Light source 210 may be, for example, a conventional LED capable of being pulsed in micro-second intervals. Light guide 211 may comprise an optical fiber or a series of mirrors and lenses. Multiple light guides may be used for a single light source in order to provide geometrically homogeneous illumination. Alternatively, multiple light sources may be used in order to illuminate coating 201 with different colors, or to provide asynchronous illumination. For instance, using three light sources may result in minimal shadowing, thereby allowing for good resolution of fine microstructure features and their colors, while a single light source may allow for better resolution of surface texture. In another embodiment, three fibers terminating in a shaped reflector near coating 201 may be used to largely eliminate shadows, while a single fiber would leave shadows visible and would therefore allow for the estimation of heights of features in the microstructure. Using shadows can also allow for the enhancement of detection of certain features, such as any features where color contrast is low, but where shape or roughness is significant, for example, grains in a case where the color of the binder is similar to the color of the grains. Using multiple colors can allow for the detection and measurement of features below the resolution of image capture device 240 where color contrast is high, for example with the presence of mixing precursors. Furthermore, the use of asynchronous illumination from different angles can allow for the improved detection of voids within coating 201 or the texture of the coating.

Focusing assembly 230 is configured to filter and focus light 225 that is reflected from coating 201. In order to account for any variable height in coating 201, the combination of a small aperture with lots of light, low magnification, and some amount of active height adjustment 280 using focusing assembly 230 may be required. According to some embodiments, focusing assembly 230 comprises a series of lenses and irises which act to direct light 225 collected from coating 201 towards image capture device 240, while minimizing any stray or reflected light (excluding light reflected from coating 201). Focusing assembly 230 may also comprise one or more of color-corrected lenses, filters, beam splitters, and reflectors. A differential interference contrast technique may be incorporated in focusing assembly 230 when viewing low-contrast features. A relatively high depth-of-field and a relatively high resolution (for example, a resolution of 1 micron with a depth-of-field of 100 microns) may be desirable in most microstructure imaging applications, and can be achieved, for instance, using a simple Huygens arrangement with color-corrected lenses. Height adjustment may be accomplished, for example as shown in FIG. 3A, with a simple linear carriage 380 connected to a driver 382, such as a cam, lead-screw, timing belt, solenoid or any other actuator device capable of fast, precise linear motion, under the control of control module 305. It shall be understood that this is only one way among known methods of achieving the desired optical characteristics.

Image capture device 240 may be a digital camera having a high sensitivity and a high signal-to-noise ratio (SNR). Relatively high sensitivity and SNR may assist in the capture of suitable images due to the motion of coating 201 relative to the camera, as described in further detail below, as well as due to the relatively low absolute light levels which are a consequence of the short duration of the light pulse emitted by light source 210. The digital camera may be a single camera or a series of individual cameras connected, for example, via a beam splitter. While a single camera may be suitable for most applications where the colors of features are easily differentiated in the visible spectrum, multiple cameras can be used when features would be better resolved in the ultraviolet or infrared spectra, and such cameras can be selected so as to provide added sensitivity in the spectra of interest.

As described above, images transferred to computer processor 250 are processed to identify features in the images and parameterize the identified features. For example, computer processor 250 may use a suitable object detection algorithm such as a convolutional neural network (CNN) classifier trained to classify each feature in the image. The object detection algorithm can be based on a version of a “You only look once” (YOLO) classifier or a U-Net, or any other trainable neural network.

Computer processor 250 may additionally employ a brightness compensation algorithm in order to compensate for fluctuations in the environmental light level by monitoring brightness when light source 210 is not emitting a light pulse. To adjust the overall light level of the image, the brightness control algorithm may use a fully algorithmic method to adjust the brightness histogram, or may use a reference light level, such as during the time when light source 210 is not active, or a combination of the two. Since different features in the image may often be only distinguishable by their respective brightness, the use of a brightness compensation algorithm may be important during the image processing.

After having identified one or more features within an image, computer processor 250 may parameterize each feature, for example by determining one or more of a size, a shape, and a color of the feature. Once a feature is identified, its size can be calculated, for example, by counting the number of pixels in the captured image within the boundary of the feature. The size may also be determined by calculating the major and minor axes of the feature or by comparing the perimeter of the feature to its area. The color can be determined, for example, as either the mean, median, or some other moment of a distribution of color of all pixels in the feature. According to some embodiments, the size of an identified feature can range from 0.5 μm to 100 μm, with about 10 μm being typical.

As can be seen from the above, the system is configured to identify and parameterize (for example, measure a size or a shape of) specific features in each image. After having identified and parameterized a number of different features, an anomaly detection algorithm may be applied to the parameterized features. The system may therefore be configured to identify potential anomalies in the surface based on multiple different parameters and across multiple different features using conventional methods such as statistical sensitivity analysis or outlier detection (such as DBScan), or through the creation of application-specific neural network-based encoder-classifiers. Generally, performing anomaly detection on the parameterized features will lead to improved results over the use of an anomaly detection algorithm on its own, which would generally be configured to look for overall difference between images and thereby classify the images as a whole.

Results generated by computer processor 250 may be transmitted to a remote location. For example, results may be transmitted to a user device (such as a mobile device or a desktop computer) for display thereon. The data may also be stored on one or more computer-readable media, for future access.

FIG. 3A is a schematic illustration of a coated substrate moving upward (as indicated by chevron arrows) through a series of rollers in a manufacturing operation, and FIG. 3B shows in more detail an apparatus 375 used to both illuminate the surface of the coated substrate and to collect light reflected from the surface. An example embodiment 300 of system 200 illustrates various components used for evaluating the microstructure of the coating 301 on the moving substrate. As shown in FIG. 3B, a light source 310 is optically coupled to light guides 311, which may be implemented as multiple optical fibers that terminate at a light concentration assembly 312 positioned in close proximity (e.g., less than 50 millimeters) to coating 301. Controller 305 pulses the light source 310 as required by the application.

The light reflected off coating 301 is focused onto an image capture device 340 using a focusing assembly 330. Images captured by the image capture device 340 are sent to processor 350 for subsequent processing of the captured images. In one embodiment, the processor 350 and controller 305 are integrated into a single processor-based device. In another embodiment, the controller 305 may be a hard-wired circuit or an ASIC configured for basic control of the emitted light parameters. It should be noted in the illustrated embodiment showing apparatus 375 that focusing assembly 330 is physically connected to light concentration assembly 312 as well as to image capture device 340.

As can also be seen in FIG. 3A, coating 301 is being analyzed using two separate inspection stations with apparatus 375a and 375b respectively, each inspection station comprising a light source 310, light guide(s) 311, light concentration assembly 312, focusing assembly 330, and image capture device 340 and a linear carriage 380 for height adjustment. Any number of inspection stations may be used to analyze coating 301, depending on the application. As noted above, coating 301 is in motion relative to apparatus 375a, 375b. The speed of motion can typically range from 0.1 to 3 m/s, with 1 m/s being most typical.

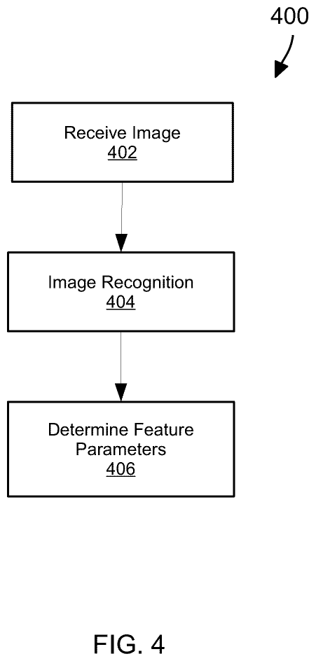

Referring now to FIG. 4, one simple example of processing step 106 as shown in FIG. 1 is illustrated. Processing flow 400 receives one or more images in step 402 and performs image recognition in step 404. The recognition of surface features of interest in the image data, such as pores, grains, etc., is driven by one or more machine learning models configured with a known image recognition program and initially trained with historical data. Results collected over time can be fed back into the model as additional training sets to improve the image recognition capabilities. In step 406, relevant parameters for the recognized surface feature are determined from the image data, such as size, shape, location, spatial distribution and color, as appropriate.

While the disclosure has been presented in the context of identifying and parameterizing one or more microstructure features of a battery electrode, the disclosure extends to other types of manufactured surfaces. For example, a system may be configured to evaluate the microstructure of photovoltaic panels manufactured via a series of surface layers, or to evaluate the chemical processing of surfaces such as those of catalytic converters and CO₂ capture materials.

The creation and use of processor-based models for image detection and analysis can be desktop-based, i.e., standalone, or part of a networked system; but given the heavy loads of information to be processed and displayed with some interactivity, processor capabilities (CPU, RAM, etc.) should be current state-of-the-art to maximize effectiveness. In the semiconductor foundry environment, the Exensio® analytics platform is a useful choice for building interactive GUI templates. In one embodiment, coding of the processing routines may be done using Spotfire® analytics software version 7.11 or above, which is compatible with Python object-oriented programming language, used primarily for coding machine language models.

Any of the processors used in the foregoing embodiments may comprise, for example, a processing unit (such as a processor, microprocessor, or programmable logic controller) or a microcontroller (which comprises both a processing unit and a non-transitory computer readable medium). Examples of computer-readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

1. A method, comprising:
obtaining an image of a manufactured surface;
processing the image to detect and identify a microstructure feature of the surface;
generating a parameter that characterizes the identified microstructure feature; and
using the generated parameter to evaluate quality of the manufactured surface.

2. The method of claim 1, further comprising:
comparing the generated parameter to a predefined threshold or set of limits for the identified microstructure feature; and
taking remedial action either upstream or downstream in a process for making the manufactured surface when the generated parameter exceeds the predefined threshold or is out of limits.

3. A method for evaluating the microstructure of a surface, comprising:
illuminating a surface of interest;
capturing at least a first digital image of the illuminated surface;
identifying in the first digital image at least a first microstructure feature associated with the surface;
determining at least a first parameter of the first microstructure feature;
comparing the first parameter to a predefined threshold or a set of limits; and
taking remedial action either upstream or downstream in a process for manufacturing the surface when the first parameter exceeds the predefined threshold or is out of limits.

4. The method of claim 3, the identifying step further comprising:
identifying the first microstructure feature as one of the following: a pore of the microstructure;
a grain of active material in the microstructure; a clump of active or inactive material in the microstructure; a texture of the microstructure; a mixing precursor in the microstructure; a distribution of binder material in the microstructure; an external contaminant or a distortion in the surface coating.

5. The method of claim 3, the determining step further comprising:
determining the first parameter to be a size, or a shape, or a spatial distribution, or a color of the first microstructure feature.

6. The method of claim 3, the capturing step further comprises:
focusing light reflected from the illuminated surface onto an image capture device; and
capturing the first image using the image capture device.

7. The method of claim 3, further comprising:
the illuminating step and the capturing step are performed at fixed points while the surface is moving.

8. The method of claim 3, the illuminating step further comprises:
pulsing a light source to illuminate the surface.

9. The method of claim 8, further comprising:
pulsing the light source with light pulses each light pulse having with a pulse width ranging from 1 microsecond to 100 microseconds.

10. The method of claim 8, further comprising:
pulsing the light source with light pulses spaced apart by up to 1 second.

11. The method of claim 8, further comprising:
pulsing a plurality of light sources to illuminate the surface.

12. The method of claim 11, wherein each of the plurality of light sources emits a different color.

13. The method of claim 8, further comprising:
monitoring an ambient brightness adjacent the surface; and
adjusting an intensity of the light source based on the ambient brightness.

14. The method of claim 3, the determining step further comprising:
determining a number of pixels in a portion of the first digital image that correspond to the first microstructure feature.

15. The method of claim 14, the step of determining the number of pixels further comprises:
comparing a major axis to a minor axis in the portion of the first digital image.

16. The method of claim 14, the step of determining the number of pixels further comprises:
comparing an area of the portion to a perimeter of the portion of the first digital image.

17. The method of claim 14, the determining step further comprising:
determining an average color based on a color of each pixel in a portion of the first digital image corresponding to the first microstructure feature.

18. The method of claim 8, the illuminating step further comprises:
guiding the light emitted by the at least one light source to a light concentration assembly and then concentrating the guided light onto the surface.

19. The method of claim 3, wherein the surface comprises a coating on a substrate.

20. The method of claim 3, wherein the surface comprises a coating for an anode or a cathode of a battery.

21. The method of claim 3, further comprising:
determining, based on the determined first parameter, whether an anomaly is present in the surface.

22. A system for evaluating the microstructure of a surface, comprising:
an illumination module positioned to emit light to illuminate at least a portion of the surface;
an imaging module positioned to capture reflected light from the illuminated portion of the surface as at least one image; and
a processing module communicatively coupled to the imaging module and programmed with instructions to analyze the image and detect a microstructure feature, identify the detected microstructure feature, and parameterize the identified microstructure feature.

23. The system of claim 22, the illumination module further comprises at least one light source.

24. The system of claim 23, further comprising a light guide and a light concentrator coupled with the light source.

25. The system of claim 24, the light guide further comprising at least one optical fiber.

26. The system of claim 22, the illumination module further comprises a plurality of light sources.

27. The system of claim 22, the imaging module further comprises a digital camera.

28. The system of claim 27, further comprising a focusing assembly coupled with the digital camera.

29. The system of claim 23, further comprising:
a control module coupled with the illumination module and configured to pulse the light source.
